(19) United States
(12) Patent Application Publication
(10) Pub. No.: US 2011/0314077 A1
(43) Pub. Date: Dec. 22, 2011

(54) IDENTIFICATION OF COMPATIBLE PRODUCTS FOR USE WITH MOBILE DEVICES

(76) Inventors: Serhat Pala, San Diego, CA (US); Deniz Turkmen, San Diego, CA (US)

(21) Appl. No.: 12/817,044

(22) Filed: Jun. 16, 2010

(51) Int. Cl. G06F 15/16

(52) U.S. Cl. 709/202

(57) ABSTRACT

The present provides an automated technique for identifying compatible products and components of a mobile, wireless Internet enabled device. In an embodiment of the invention, a user of the wireless device requests a web page of an appropriate web site, e.g., a web site pertaining to that of a product and component retailer, which is facilitated by a web server. The web server obtains the respective user agent signature corresponding to the user's web browser. The server then analyzes the user agent signature to identify, among other things, the make and model of the user's device. By knowing the make and model of the user's device, the web server can then query a database to determine compatible products and components for use with the device. The web server then displays those compatible products and components and can facilitate the purchase of those products and components by the user.

### BACKGROUND OF THE INVENTION

1. Field of Invention

The present invention relates to mobile devices, e.g., Internet-enabled devices such as, but not limited to smartphones, personal digital assistants, cellphones, handheld computers, and tablets, and more specifically, to a technique for identifying compatible products for use with particular mobile devices.

2. Description of Related Art

With the commercial success of Internet and multimedia-enabled smartphones, such as the widely successful iPhone by Apple Inc., Internet access is increasingly becoming more convenient and geographically available to users. Generally, every Internet-enabled device includes some form of a web browser. A web browser is a software application for retrieving, presenting, and traversing information resources on the World Wide Web, which is generally referred to as a system of interlinked hypertext documents accessed via the Internet. With a web browser, one can view web pages that may contain text, images, videos, and other multimedia and navigate between them by using hyperlinks. A web site is identified by a Uniform Resource Identifier (URI) and may be a web page, image, video, or other piece of content. There are numerous web browsers commercially available today, which can be differentiated from one another by, among other things, creator, compatibility with various computer operating systems, and the degree that open source code is implemented. Example web browsers include Internet Explorer by Microsoft, Firefox by Mozilla, Chrome by Google, Safari by Apple, and Opera by Opera Software, which collectively account for over 99% of browser usage share as of April 2010.

A user agent is a client application implementing a network protocol used in communications within a client-server distributed computing system. The term user agent most notably refers to applications, such as a web browser, that access the World Wide Web—today, nearly everyone uses a web browser as their user agent. Often, it is necessary for a web server to understand how its web pages are being viewed, so user agents typically identify themselves by sending a user agent string to the web server—a string is a series of characters, usually letters and numbers (often in binary representation). Different web browsers therefore identify themselves with different user agent strings. A user agent string typically identifies, among other things, the web browser type and version, the make and model of the device the browser is installed on, and the operating system being implemented on that device. For example, FIG. 1 illustrates exemplary user agent strings for common Internet-enabled devices.

User agent strings are used by a web server to characterize the client and optionally select suitable content or operating parameters for the communications session. The user agent string can be analyzed by the web server to provide properly formatted content for desktop computers and particularly smartphones. For example, U.S. Pat. No. 6,412,008, the disclosure of which is herein incorporated by reference it is entirety, discloses a technique for customizing web pages based on the browser identified in a user agent string. U.S. Patent Application Publication No. 2008/0235800, the disclosure of which is herein incorporated by reference in its entirety, discloses a technique for determining anti-virus protection status based on analysis of a user agent string. In general, analysis of user agent strings has been limited to tailoring content or determining session parameters for a particular device. However, no conventional techniques are known to analyze a user agent string for the purpose of identifying compatible products for use with a particular device.

### SUMMARY OF THE INVENTION

The present invention overcomes these and other deficiencies of the prior art by providing an automated technique for identifying compatible products and components of a mobile, wireless Internet enabled device. A user of the wireless device requests a web page of an appropriate web site, e.g., a web site pertaining to that of a product and component retailer, which is facilitated by a web server. The web server receives the respective user agent signature corresponding to the user's web browser. The server then analyzes the user agent string by parsing and comparing the parsed pieces with known user agents strings associated with particular makes and models of devices. By knowing the make and model of the user's device, the web server can then query a database to determine compatible products and components for use with the device. The web server then displays those compatible products and components and can facilitate the purchase of those products and components by the user.

In an embodiment of the invention, a method implemented on a server comprises the steps of: receiving a user agent string, at the server, from a user agent installed on a device; identifying a make and/or model of the device associated with the user agent string, and identifying one or more compatible products or components for use with the device. The step of identifying comprises the steps of: parsing the user agent string into pieces; comparing one or more of the pieces against a database of user agent strings associated with various devices, and determining the best match between the one or more compared pieces and the database of user agent strings. The method can further comprise the step of transmitting information pertaining to the identified one or more compatible products or components to the device. The information can be included as part of a web page. The method may further comprise the step of facilitating purchase of one of the identified one or more compatible products or components. The web page may comprise a link to another web page for facilitating purchase of one of the identified one or more compatible products or components. The one or more compatible products or components are selected from the group consisting of: screen protectors, cases and pouches, earphones and headsets, software and applications, chargers and adapters, cradles and holders, vehicle compatibility adapters, cables, storage media, battery, rechargers, input devices such as a mouse or keyboard, cleaning accessories, speakers and projectors, stylus and writing devices, audio and video accessories and attachments (both recording and playing), payment system attachments, scanning device attachments, game and learning device attachments, modems, and any combination thereof.

In another embodiment of the invention, a method implemented on a server comprises the steps of: receiving a user agent profile, at the server, from a device; identifying a make and/or model of the device associated with the user agent profile, and identifying one or more compatible products and components for use with the device. The step identifying a make and/or model of the device associated with the user agent profile comprises the steps of: parsing the user agent profile into pieces; comparing one or more of the pieces against a database of user agent profiles associated with various devices, and determining the best match between the one or more compared pieces and the database of user agent profiles. The method may further comprise the step of transmitting information pertaining to the identified one or more compatible products or components to the device. The information can be included as part of a web page. The method may further comprise the step of facilitating purchase of one of the identified one or more compatible products or components. The web page may comprise a link to another web page for facilitating purchase of one of the identified one or more compatible products or components. The one or more compatible products or components are selected from the group consisting of: screen protectors, cases and pouches, earphones and headsets, software and applications, chargers and adapters, cradles and holders, vehicle compatibility adapters, cables, storage media, battery, rechargers, input devices such as a mouse or keyboard, cleaning accessories, speakers and projectors, stylus and writing devices, audio and video accessories and attachments (both recording and playing), payment system attachments, scanning device attachments, game and learning device attachments, modems, and any combination thereof.

In another embodiment of the invention, a method implemented on a mobile device comprises the steps of: sending a user agent string or profile from the mobile device to a server; receiving information identifying a make and/or model of the mobile device associated with the user agent string or profile, and receiving information identifying one or more compatible products and components for use with the device.

An advantage of the invention is that the sale of compatible products and components with a user's device is centralized and facilitated by a remote web server, which automatically identifies those compatible products and components in real-time or near real- time.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows:

FIG. 1 illustrates exemplary user agent strings for common Internet-enabled devices; and

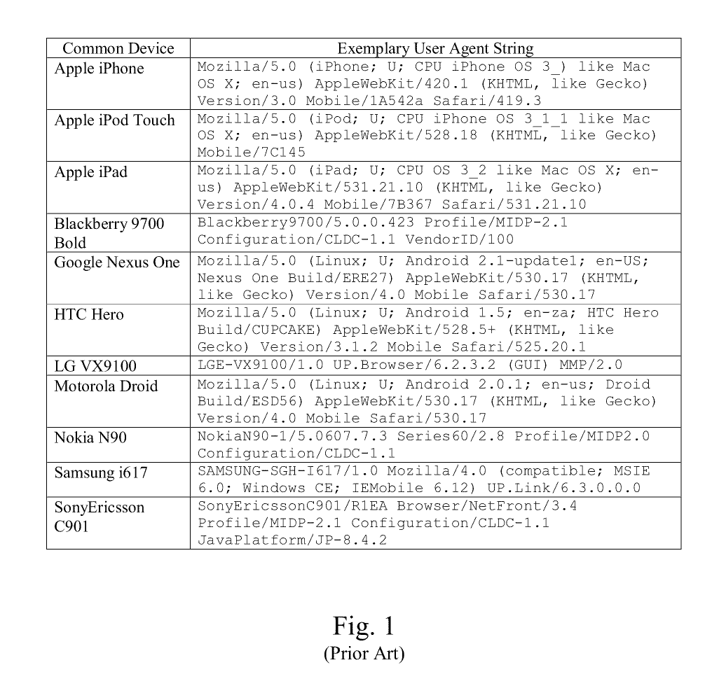

FIG. 2 illustrates a computer system for identifying compatible components for a wireless device according to an embodiment of the invention.

### DETAILED DESCRIPTION OF EMBODIMENTS

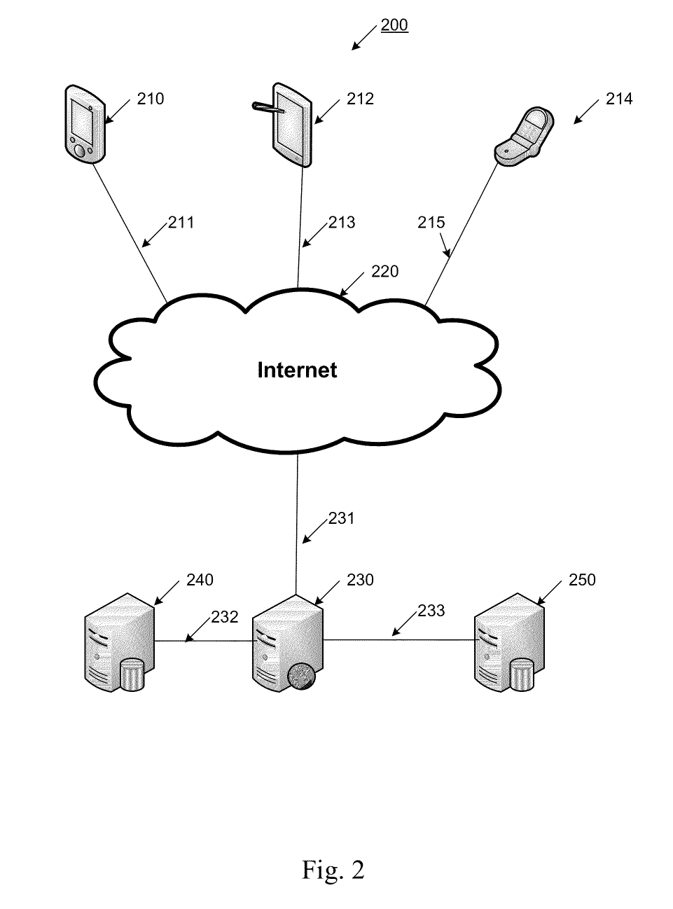

Further features and advantages of the invention, as well as the structure and operation of various embodiments of the invention, are described in detail below with reference to the accompanying FIG. 2. Although the present invention is described in the context of wireless mobile Internet-enabled devices, one of ordinary skill in the art readily appreciates that the present invention is applicable to any type of Internet-enabled device that can be identified through analysis of a user agent string or user agent profile.

In an exemplary embodiment of the invention, an automated technique for identifying compatible products and components of a mobile, wireless Internet enabled device is provided. A user of the wireless device requests a web page of an appropriate web site, e.g., a web site pertaining to that of a product and component retailer, which is facilitated by a web server. The web server receives the respective user agent signature corresponding to the user's web browser. The server then parses the user agent signature to identify, among other things, the make and model of the user's device. By knowing the make and model of the user's device, the web server can then query a database to determine compatible products and components for use with the device. The web server then displays those compatible products and components and can facilitate the purchase of those products and components by the user.

FIG. 2 illustrates a computer system 200 for identifying compatible components for a wireless device according to an embodiment of the invention. Particularly, the computer system 200 comprises a smartphone 210, a tablet computer 212, a cellphone 214, a communications network 220, a web server 230, a database server 240, and a combined web/database server 250. One of ordinary skill in the art appreciates that inclusion of the smartphone 210, the tablet computer 212, and the cellphone 214 is exemplary only for illustrative purposes and that any number of various types of Internet-enabled devices can be coupled to the communications network 220. The smartphone 210, the tablet computer 212, and the cellphone 214 each comprise a user agent such as a web browser.

As shown, the smartphone 210, the tablet computer 212, and the cellphone 214 are coupled to the communications network 220 via respective communications links 211, 213, and 215. In an exemplary embodiment of the invention, the communications links 211, 213, and 215 comprise wireless communications links such as, but not limited to an IEEE 802.11 standard (commonly referred to as Wi-Fi) communications link or a cellular communications link implementing, for example, a transmission control protocol/Internet protocol (TCP/IP) communications standard. However, one of ordinary skill in the art readily appreciates that any type of wired or wireless communications link (or combinations of links), as well as any type of communications standard, can be implemented to couple the smartphone 210, the tablet computer 212, and the cellphone 214 to the communications network 220. In a preferred embodiment of the invention, the communications network 220 is the Internet.

The web server 230, the database server 240, and the web/database server 250 are coupled to the communications network 220 and one another via respective communications links 231, 232, and 233. In an exemplary embodiment, the communications links 231, 232, and 233 each comprise a wired multiplexed communications link such as, but not limited to a digital signal 1 (DS1 or “T1”) line implementing the TCP/IP communications standard. However, like above, one of ordinary skill in the art readily appreciates that any type of wired or wireless communications link (or combinations of links), as well as any type of communications standard, can be implemented to interconnect the web server 230, the database server 240, the web/database server 250, and the communications network 220.

The database server 240 comprises a database of products and components deemed compatible with different makes and models of Internet-enabled devices. The term “compatible” is used herein to refer to certain products and components that can be used with a specific make and model of an Internet-enabled device. For example, the database server 240 comprises a list of compatible products and components for use with an iPhone, a list of compatible products and components for use with a Blackberry 9700 Bold, and so on for each commercially available Internet-enabled device. Exemplary compatible products and components include, but are not limited to screen protectors, cases and pouches, earphones and headsets, software and applications, chargers and adapters, cradles and holders, vehicle compatibility adapters, cables, storage media, battery, rechargers, input devices such as a mouse or keyboard, cleaning accessories, speakers and projectors, stylus and writing devices, audio and video accessories and attachments (both recording and playing), payment system attachments, scanning device attachments, game and learning device attachments, and modems.

The web/database server 250 comprises a database of historical user agent strings associated with specific makes and models of Internet-enabled devices. For example, the web server 230 transmits the user agent string to the web/database server 250, which parses the string into pieces and compares the pieces against stored user agent strings. Based on the best match from the comparison, the web/database server 250 can identify the make and the model of the respective device. The web/database server 250 transmits the make and/or model to the web server 230. In an alternative embodiment of the invention, the servers 230, 240, and 250 can be combined into a single server. Whether combined or distributed, the database portions of servers 240 and 250 implement a standard database management system (DBMS) implementing a standard query language (SQL) for managing data, the implementation of which is apparent to one of ordinary skill in the art.

In operation, the web server 230 provides data and content to the smartphone 210, the tablet computer 212, and the cellphone 214 via the communications network 220 and the respective links. When the smartphone 210, the tablet computer 212, or the cellphone 214 requests access to the web server 230 (e.g., requests a web page), the respective user agent of that device sends a user agent string to the web server 230. For example, if the smartphone 210 is an iPhone by Apple, it may send a user agent string of “Mozilla/5.0 (iPhone; U; CPU iPhone OS 3_) like Mac OS X; en-us) AppleWebKit/420.1 (KHTML, like Gecko) Version/3.0 Mobile/1A542a Safari/419.3.” The web server 230 will then send this information to the server 250. The server 250 will identify the smartphone 210 as an iPhone by, for example, parsing the user agent string, the implementation of which is apparent to one of ordinary skill in the art, and comparing the parsed pieces against known user agent strings stored in its database. The server 250 will send the make and/or model of the iPhone to the web server 230. Once the web server 230 knows the make and model as an iPhone, it can query the database server 240 to identify compatible products and components. The web server 230 then transmits identification of these compatible products and components to the smartphone 210 via a web page. The web page can comprise other information such as, but not limited to pricing information and links to facilitate purchase and delivery of products and components selected by the user of the smartphone 210. Alternatively, the web page can include a link that directs the user to another web page (or web server) that provides pricing information and facilitates purchase and delivery of the products and components.

In an alternative embodiment of the invention, a user agent profile (UAProf) is implemented instead of a user agent string. A user agent profile is a file specifying capability and preference information for wireless devices. A user agent profile describes the capabilities of a mobile handset, including, among other things, the make, model, screensize, and multimedia capabilities of the respective device. A mobile handset sends a header within an hypertext transmission protocol (HTTP) request, containing the URI to its UAProf. The HTTP header is usually “x-wap-profile,” but sometimes may look more like “19-profile,” “wap-profile” or a number of other similar headers.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

We claim:

1. A method implemented on a server, the method comprising the steps of:
receiving a user agent string, at the server, from a user agent installed on a device;
identifying a make and/or model of the device associated with the user agent string, and
identifying one or more compatible products or components for use with the device.

2. The method of claim 1, wherein the step of identifying a make and/or model of the device associated with the user agent string comprises the steps of:
parsing the user agent string into pieces;
comparing one or more of the pieces against a database of user agent strings associated with various devices, and
determining the best match between the one or more compared pieces and the database of user agent strings.

3. The method of claim 1, further comprising the step of transmitting information pertaining to the identified one or more compatible products or components to the device.

4. The method of claim 3, wherein the information is included as part of a web page.

5. The method of claim 4, further comprising the step of facilitating purchase of one of the identified one or more compatible products or components.

6. The method of claim 4, wherein the web page comprises a link to another web page for facilitating purchase of one of the identified one or more compatible products or components.

7. The method of claim 1, wherein the one or more compatible products or components are selected from the group consisting of: screen protectors, cases and pouches, earphones and headsets, software and applications, chargers and adapters, cradles and holders, vehicle compatibility adapters, cables, storage media, battery, rechargers, input devices such as a mouse or keyboard, cleaning accessories, speakers and projectors, stylus and writing devices, audio and video accessories and attachments (both recording and playing), payment system attachments, scanning device attachments, game and learning device attachments, modems, and any combination thereof.

8. A method implemented on a server, the method comprising the steps of:
receiving a user agent profile, at the server, from a device;
identifying a make and/or model of the device associated with the user agent profile, and
identifying one or more compatible products and components for use with the device.

9. The method of claim 8, wherein the step of identifying a make and/or model of the device associated with the user agent profile comprises the steps of:
parsing the user agent profile into pieces;
comparing one or more of the pieces against a database of user agent profiles associated with various devices, and
determining the best match between the one or more compared pieces and the database of user agent profiles.

10. The method of claim 8, further comprising the step of transmitting information pertaining to the identified one or more compatible products or components to the device.

11. The method of claim 10, wherein the information is included as part of a web page.

12. The method of claim 11, further comprising the step of facilitating purchase of one of the identified one or more compatible products or components.

13. The method of claim 11, wherein the web page comprises a link to another web page for facilitating purchase of one of the identified one or more compatible products or components.

14. The method of claim 8, wherein the one or more compatible products or components are selected from the group consisting of: screen protectors, cases and pouches, earphones and headsets, software and applications, chargers and adapters, cradles and holders, vehicle compatibility adapters, cables, storage media, battery, rechargers, input devices such as a mouse or keyboard, cleaning accessories, speakers and projectors, stylus and writing devices, audio and video accessories and attachments (both recording and playing), payment system attachments, scanning device attachments, game and learning device attachments, modems, and any combination thereof.

15. A method implemented on a mobile device, the method comprising the steps of:
sending a user agent string or profile from the mobile device to a server;
receiving information identifying a make and/or model of the mobile device associated with the user agent string or profile, and
receiving information identifying one or more compatible products and components for use with the device.
